(19) United States
(12) Patent Application Publication
(10) Pub. No.: US 2025/0369403 A1
(43) Pub. Date: Dec. 4, 2025

(54) Exhaust Moderated Optimized Combustion Intake

(71) Applicant: Niilo William Alexander Koponen, Fairbanks, AK (US)

(72) Inventor: Niilo William Alexander Koponen, Fairbanks, AK (US)

(21) Appl. No.: 18/679,977

(22) Filed: May 31, 2024

(51) Int. Cl. F02D 41/00; F02M 25/022; F02M 25/028

(52) U.S. Cl. CPC F02D 41/0002; F02D 41/0055; F02M 25/0227; F02M 25/028; F02D 2041/0017

(57) ABSTRACT

In contrast to historic combustion intakes that vary fuel to air ratios to control output, this invention allows optimal fuel to air ratio throughout the output range with the heart of the EMOCI invention being the throttle valve that determines combustion output by selecting and displacing the chosen percentage of combustible air or air-fuel mixture flow going into the combustion chamber with the effectively inert, recycled exhaust. This recycled exhaust is also the primary way of keeping combustion temperatures low enough to avoid thermal NOx production. Water injection may also be used to keep the temperature low enough to prevent thermal NOx production. The body of the invention is the long inlet, the fuel in an optimum ratio with the air being added near the start, and stretching past the throttle valve. This length giving time for the fuel to vaporize enough so that it burns cleanly and completely.

### FIELD

This patent relates to providing optimal fuel to air ratios for maximizing combustion efficiency while minimizing pollution from the combustion of fuels for power, heat and light.

### BACKGROUND

Humans have used fire for heat and lighting for many thousands of years. Hundreds of years ago, with the advent of steam power, we started to use it for power as well. More recently we have internal combustion engines taking advantage of the expansion pressure exerted when fuel combusts.

Fire commonly uses the oxygen in the air with a material, typically carbon, in an exothermic reaction to create light but primarily the heat of the reaction, which causes the expansion of the gases that in internal combustion engines (ICE) is used for generating power. Depending upon the reactants the combustion reaction often has the products of carbon dioxide and water vapor as well as heat. However many factors result in less desired byproducts while reducing that which is desired.

Many variants of external combustion and internal combustion uses exist, are used and in production today. Fuels continue to be used for power, heating and lighting. Whether by adding another log to the fire or injecting fuel into a combustion chamber these all use the control of the quantity of fuel added as the primary method to determine (or throttle) the output.

Whether by blowing on the fire, just allowing or blocking natural airflow or by pumping air to the combustion the control of the air in the combustion is traditionally a secondary method of determining the output.

For power production using engines that use the expansion of the burning gases to turn a crankshaft the air (with or without the fuel) has to enter a combustion chamber, be compressed, have fuel added if it was not already mixed with the air just prior to entering the chamber and get the mixture ignited in order for the expansion to power the turning of the crankshaft.

For production of heat or light that does not rely upon compression and expansion of an incoming fuel-air mixture the air enters the combustion location (known by various names such as firebox, furnace et cetera, herein referred to as combustion chamber), the fuel is added, ignited and combusts.

The method of controlling the fuel as the throttling mechanism has an inherent limitation on the distance before combustion that the fuel can be mixed with air. Even spark ignition engines mix the fuel with the air very close before the combustion chamber due to response time to throttling changes being dependent upon the distance.

Two problems with this method used for control are that:
One—the fuel often does not adequately vaporize and mix with the air sufficiently. This causes incomplete combustion resulting in the generation of pollution such as carbon monoxide (which only has an OSHA 8 hour permissible exposure limit of 50 ppm, 1% that of carbon dioxide) and soot along with less than maximal power, heat, or light.

Two—the problem of thermal NOx production when the combustion temperature gets too hot. At high enough combustion temperatures the energy is high enough to push the oxygen atoms into combining with the nitrogen atoms in the air. This endothermic reaction reduces the output while generating NOx pollution as well as decreasing the amount of oxygen available to combine with fuel. These high temperatures are most prevalent when the fuel to air ratios are close to the optimal stoichiometric ratios where there is just enough oxygen for the fuel and just enough fuel for the oxygen.

While some designs burn fuels exclusively in a lean (more oxygen than the fuel requires) fashion and others burn fuels exclusively in a rich (more fuel and less oxygen leading to a cooler, less efficient, carbon monoxide producing reaction replacing some of the more exothermic carbon dioxide producing reaction), many are adjustable and switch from lean to rich and back again depending upon need. These may momentarily be at the optimal stoichiometric fuel to air ratio during the transition. Lean mixtures heating more air than combustion requires. Rich mixtures producing more output per second but being less efficient in getting output from the fuel.

Prior art relevant to this invention are the use of blowers (including super chargers and turbochargers) to push air towards (or pull from) the combustion location, Exhaust Gas Recirculation (EGR) used to reduce the pollution generated by internal combustion engines via the adding of inert exhaust gases to cool the combustion and water and/or other matter (such as ethanol) injection used to modify the incoming air or air-fuel mixture. Many sensors, often combined with an electronic control unit, have been used in a variety of ways to monitor and control the inputs and outputs.

### SUMMARY

The fundamental change that this invention, the Exhaust Moderated Optimized Combustion Intake (EMOCI) makes is, instead of using control of the fuel or air as the throttling mechanism, it uses Exhaust Gas Recirculation (EGR) displacement of controlled quantities of incoming air or fuel-air mixture with effectively inert recycled exhaust as the throttling mechanism. This allows for continuous use throughout the output demand curve of the optimal stoichiometric ratio of fuel to air with the fuel to be mixed with the air far enough in advance of the combustion so that it has fully vaporized resulting in complete and clean combustion. Used this way EGR has the additional virtue of cooling the combustion while not disrupting the stoichiometric fuel to air ratio.

For output levels high enough when EGR is not sufficient or present to avoid thermal NOx production the use of a controlled amount of water and/or other matter (such as ethanol) injection cools the combustion to keep the combustion temperature low enough to avoid the wasteful and polluting production of NOx as well as being used to modify the incoming air-fuel mixture for the prior purpose of cooling the incoming air-fuel mixture, the increased density allowing more to enter the combustion chamber, as well as using the expansion of the injected matter to provide additional power.

When using fuels (such as solid fuels) that are not vaporized prior to entering the combustion chamber EMOCI simply uses EGR and/or water to mix with the incoming air in such ratios as will keep the combustion temperature low enough to avoid thermal NOx production while also controlling the rate of combustion.

The EMOCI is essentially a tube that on one end takes in (hopefully clean or filtered) air and on the other end leads to the combustion chamber after it has gone through the following steps in the EMOCI. The EMOCI:

Has a blower if the combustion mechanism is not drawing enough air in by reducing the air pressure in the tube (as most naturally aspirated internal combustion engines do).

Is encouraged to have a capping mechanism to keep the air-fuel mixture from leaking out into the atmosphere when the EMOCI is not in use.

Has a method of introducing fuel into the incoming air (likely by venturi carburation or injection). Optimally this should be set to introduce just enough fuel to ensure a stoichiometric combustion ratio with the incoming air. The smaller the droplets the quicker the vaporization. [While this ratio may be varied, as for example to provide more power and cooling at the cost of less efficiency and having CO in the exhaust, or to account for ethanol or other secondary fuel injection, in most circumstances a stoichiometric ratio is best.]

Has enough length (spiral design may reduce space and material requirements.) so that the fuel has enough time before reaching the combustion phase that it has been able to adequately vaporize. Heating or introducing swirling to the flow may shorten the length necessary. [While this step can be skipped, particularly in the use of solid fuels, and the fuel delivered closer or directly to the combustion chamber, the advantage of complete vaporization may be lost.] Optionally an intercooler may cause the mix to be denser before combustion to allow more of the mix to enter the combustion chamber and further control the combustion temperature.

Has controlled water (and/or other matter such as ethanol) injection to prevent combustion temperatures from getting high enough to cause the formation of thermal NOx. While EMOCI can be used without this, at higher output settings this may cause some NOx pollution while wasting some energy. Timing and or boost may need adjustment to take advantage of the injection.

Has a control (throttle) mechanism (such as a Y passage ball valve as shown in the drawing) to introduce controlled quantities of recycled exhaust to displace some (or all when turned off) incoming air or air-fuel mixture and to dilute and mix with the remainder. [Alternatively the exhaust could have its own channel into the combustion chamber, but this may have the downside of inadequate mixing leading to localized hot spots with resultant NOx production.]

Has an Exhaust Gas Recirculation (EGR) system to recycle exhaust as needed from the exhaust back to the throttle valve. Additionally, while optional as water can be supplied from storage or omitted entirely, as one of the primary products of combustion is water vapor, water can also be recycled from the exhaust that, when cooled back into liquid form in a condenser, will be available for reuse to cool combustion.

Has a method to prevent premature ignition of the air-fuel mixture before it reaches the combustion chamber. Timing and valves work for engines while use of a flame arrester around the combustion chamber may provide furnaces with the air-fuel mixture in a safe manner. [Design, construction and maintenance of ECOMI is important in preventing ignition sources reaching the air-fuel mixture before the combustion chamber.]

A multitude of sensors and feedback options exist to determine the optimal rates for air, fuel, water and recycled exhaust for each throttle setting. Each design can have preset mechanisms that minimize the requirements for such sensors while still providing optimal combustion.

### BRIEF DESCRIPTION OF THE DRAWING

FIG. 1 depicts the applicable parts mentioned in this patent application and shows them in the most likely arrangement for use.

1. Filter, used to assure cleanliness of incoming air.
2. Blower, optional method of forcing air into the intake.
3. Valve or Cap closed to prevent leakage of air-fuel mixture when the intake is not in use. Otherwise wide open to minimize air blockage.
4. Fuel Injector or other method of mixing optimal amount of fuel into the incoming air.
5. EMOCI Tube long enough to give fuel droplets time to vaporize sufficiently for clean and complete combustion.
6. Water Injector, optional method of limiting maximum combustion temperature when insufficient EGR is mixed in via the throttle.
7. Throttle used for controlling output via displacement of air or air-fuel mixture with recycled exhaust before the combination goes into the combustion chamber.
8. EGR inlet for Throttle is the alternate inlet to the throttle aside from the EMOCI tube, the relative combination of the two inlets determining the output.
9. Outlet to Combustion Chamber Manifold is where the combination of air, fuel and recycled exhaust leaves the EMOCI in order to go into the combustion chamber.

### DETAILED DESCRIPTION

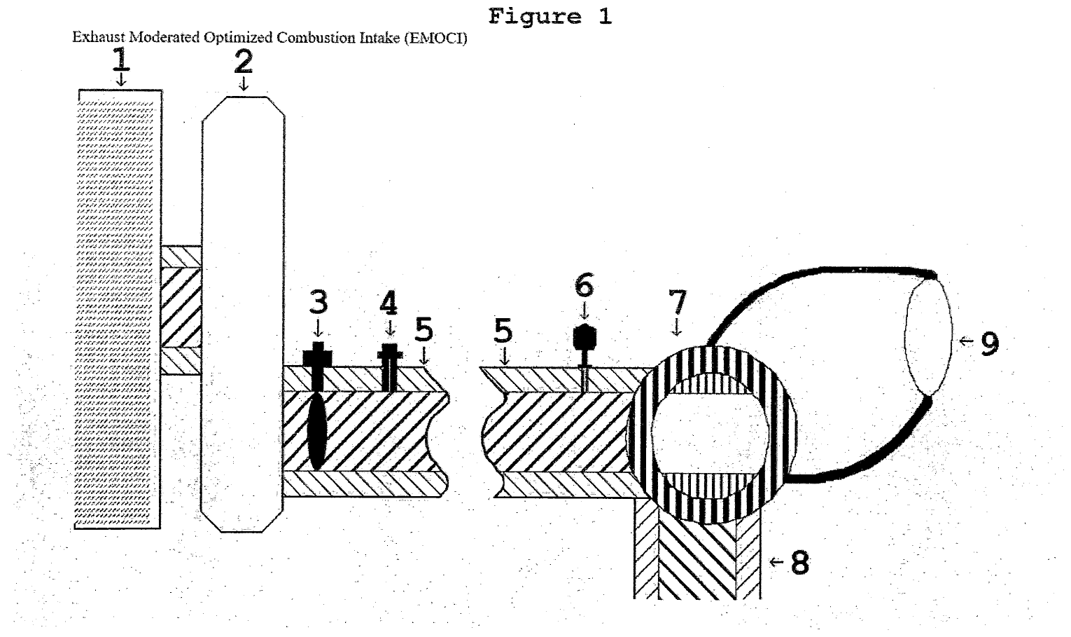

In comparison to present intake systems, the Exhaust Moderated Optimized Combustion Intake (EMOCI) shown in FIG. 1 (which includes some optional components) makes more output from fuel while resulting in less pollution. This in turn makes better use of a limited resource and improves our environment (by not generating smog and acid rain). EMOCIs can be made using items readily available in the industry while being less expensive and more effective than current anti-pollution alternatives. Furnaces and combustion engines may be suitable to be retrofitted into EMOCI designs. The cleaner exhaust results in easier carbon capture installations if desired.

### First Embodiment

### Internal Combustion Engines

As exemplified by spark and compression ignition engines, reliant upon compressing fuel-air mixtures to get their power from the subsequent expansion during the burning of the fuel-air mixture, this embodiment optimizes that combustion, increasing the efficiency and minimizing the pollution of such engines.

Clean air, optionally pumped by a blower such as a supercharger or turbocharger, passes a valve that is wide open when operating the engine and completely closes off the intake when off so as to prevent fuel-air mixture from escaping. Then it has fuel mixed (injection or venturi carburation being standard options for the mixing) in with the air, in a stoichiometric ratio during standard operation (optionally varying the mixture for certain needs). It then travels down an intake pipe long enough for the fuel to adequately vaporize into the air before passing the throttle valve where it may have some exhaust mixed in, perhaps having water (and/or other matter) injected and finally entering the combustion chamber(s), where it is compressed, ignited, and in burning expands to provide the desired power.

When desiring less than full power output, the throttle valve displaces a controlled variable quantity of fuel-air mixture with recycled exhaust, thus reducing power to the desired output. Many spark ignition and compression combustion engines have exhaust gas recirculation systems already, primarily for meeting emission standards. Modification of these designs to provide recycled exhaust to the throttle valve should be adequate for recycling of exhaust gases combining with the fuel-air mixture prior to entry into the combustion chambers. At lower power settings (using a higher mixture of exhaust gases in the combustion) the heat of combustion should not be high enough to result in thermal NOx production.

The optional inclusion of water (and/or other matter) injection in addition to cooling the intake mixture allowing for more to enter the combustion chamber, primarily is used in EMOCI at higher power settings to lower the combustion temperature to avoid wasteful and polluting NOx production. The expansion of the water upon turning to steam provides power offsetting the reduction of the combustion temperature.

### Operation—First Embodiment

To start the engine, the valve (or cap) blocking escape of the volatile fuel-air mixture out through the inlet when the engine is not operating, is opened allowing the intake of air into the EMOCI. Suction by the engine (or blower) pulls the incoming air through the filter into the optional blower and then into the inlet pipe. There fuel will be mixed with the incoming air via whatever method is chosen (venturi carburation and injection being standard methods) in a stoichiometric ratio (unless there is reason to change the ratio). Then down the intake pipe this fuel-air mixture will travel towards the combustion chamber, fuel vaporizing as it goes. The fuel droplets, depending upon their size, the temperature and the chemistry of the fuel, will need a time and thus length of intake pipe long enough to vaporize to a degree to which when combusted in the combustion chamber they will no longer be large enough to cause incomplete combustion.

The throttle, close to the combustion chamber to make throttle response quick, inputs the fuel-air mixture, displacing a variable and controlled amount of that mixture with recycled exhaust from an exhaust gas recirculation (EGR) system. More recycled exhaust in the output equaling less power as well as lower combustion temperature.

A method (likely injection but other methods can work) for inputting a controlled amount of water (and/or other matter such as ethanol) is suggested for helping to reduce combustion temperatures at higher power settings. At higher power settings with correspondingly higher combustion temperatures, the cooling from those combustion temperatures to prevent wastage of power and production of NOx pollutants is provided by this injection. The expansion from water to steam produced provides an offset to the cooling of the combustion while preventing wastage of power going into the production of NOx.

Air, fuel and recycled exhaust from the throttle then goes into the combustion chamber where they are compressed then combusted, providing the power requested.

### Second Embodiment

### External Combustion With Liquid or Gaseous Fuel

Used for heating or lighting, sometimes with the heat then used for a secondary purpose such as to heat water into steam which is then used to drive a turbine or other engine. This embodiment optimizes the combustion, increasing the efficiency and minimizing the pollution.

The incoming air is optionally filtered and/or pumped, passes a valve that is wide open when operating and completely closes off the intake when off so as to prevent fuel-air mixture from escaping, it has fuel mixed (injection or venturi carburation being standard options for the mixing) in with the air, in a stoichiometric ratio (unless there is reason to change the ratio), and then goes down an intake pipe long enough for the fuel to adequately vaporize into the air before passing the throttle valve where recycled exhaust displaces fuel-air in a ratio depending upon the desired output, past a flame arrester and into the combustion chamber(s) where it burns to provide the desired heat output.

The power output valve displaces a controlled variable quantity of fuel-air mixture with recycled exhaust, setting power to the desired output. An exhaust gas recirculation (EGR) system to recycle exhaust gases provides this exhaust. Preferably the power should be set (using the mixture of exhaust gases in the combustion) so that the heat of combustion not result in thermal NOx production.

The optional inclusion of water (and/or other matter) injection in addition to cooling the intake mixture allowing for more to enter the combustion chamber, primarily is used in EMOCI at higher power settings to lower the combustion temperature to avoid wasteful and polluting NOx production. Note that larger combustion chambers and heat transfer areas utilizing EGR could make water injection unnecessary.

Output from the throttle then goes past a flame arrester into the combustion chamber where combustion occurs, providing the output requested.

### Operation—Second Embodiment

To start, the valve (or cap) blocking escape of the volatile fuel-air mixture out through the inlet when the furnace is not operating is opened allowing the intake of air into the EMOCI. Unless there is sufficient suction by the furnace a blower pushes the incoming air (hopefully clean or filtered) into the inlet pipe. There fuel will be mixed with the incoming air via whatever method is chosen (carburation and injection being standard methods) in a stoichiometric ratio (unless there is reason to change the ratio). Then down the intake pipe this fuel-air mixture will travel towards the combustion chamber, the fuel vaporizing as it goes. The fuel droplets, depending upon their size, the temperature and the chemistry of the fuel, will need a time and thus length of intake pipe long enough to vaporize to a degree to which when combusted in the combustion chamber they will no longer be large enough to cause incomplete combustion.

The throttle, close to the combustion chamber to make throttle response quick, controls inputs from both the fuel-air mixture and recycled exhaust from the exhaust gas recirculation (EGR) system. The quantity of fuel-air mixture going to the combustion can be restricted by the throttle displacing a controlled and variable amount of that mixture with recycled exhaust via an EGR system. More recycled exhaust in the combustion equaling less heat as well as lower combustion temperature while still maintaining optimal efficiency in terms of heat produced per quantity of fuel burned.

Space considerations may require a method (likely injection but other methods can work) for inputting a controlled amount of water either before or after the throttle valve that may be used for helping to reduce combustion temperatures at higher output settings. At higher output settings with correspondingly higher combustion temperatures, the cooling from those combustion temperatures to prevent wastage of power and production of NOx pollutants is provided by this injection. Alternatively, more volume may be devoted to combustion chambers and EGR used to keep the combustion temperatures low enough to avoid NOx production.

Output from the throttle then goes through a flame arrester into the combustion chamber where combustion occurs providing the output requested.

### Third Embodiment

### External Combustion With Solid Fuels

Delivery of fuel to the combustion chamber being a route that may allow in uncontrolled quantities of air along with the varying rate that the solid fuels burn at makes fine control of the combustion difficult via delivery of fuel to the combustion chamber. Instead, by relying upon sensors observing the combustion and/or detecting factors in the exhaust, while coarse control continues via the quantity of fuel delivered into the combustion chamber, fine control of the temperature of combustion will be determined by the percentage of incoming air displaced by recycled exhaust and/or water directed into the combustion chamber.

The throttle, close to the combustion chamber to make throttle response quick enough, can mix recycled exhaust in with the incoming air. The quantity of air going to the combustion can be restricted by the throttle displacing a controlled and variable amount of air with recycled exhaust via an exhaust gas recirculation (EGR) system. More recycled exhaust in the combustion equaling less heat as well as lower combustion temperature while still maintaining optimal efficiency in terms of heat produced per quantity of fuel burned.

Either before or after the throttle valve a method (likely injection but other methods can work) for inputting a controlled amount of water may be used for helping to reduce combustion temperatures at higher output settings. At higher output settings with correspondingly higher combustion temperatures, the cooling from those combustion temperatures to prevent wastage of power and production of NOx pollutants is provided by this injection. Alternatively, more volume may be devoted to combustion chambers and EGR alone used to keep the combustion temperatures low enough to avoid NOx production.

Note that steam injection may be used to assist in clean combustion by helping reduce any lumps of hydrocarbon into smaller, cleaner burning chunks as well as spreading the flame front for better combustion.

Output from the throttle then goes into the combustion chamber where combustion occurs providing the output requested.

### Operation—Third Embodiment

To start, the valve (or cap) blocking escape of the exhaust out through the inlet when the furnace is not operating is opened allowing the intake of air into the EMOCI. Unless there is sufficient suction by the furnace a blower pushes the incoming air (hopefully clean or filtered) into the inlet pipe. This, together with the following throttle, delivers air to the combustion chamber. This should be at a rate matching the fuel supply so that the burning of the fuel is in a stoichiometric ratio (unless there is reason to change the ratio).

The throttle, close to the combustion chamber to make throttle response quick, mixes air with recycled exhaust via an exhaust gas recirculation (EGR) system. More recycled exhaust in the combustion equaling less heat as well as lower combustion temperature while still maintaining optimal efficiency in terms of heat produced per quantity of fuel burned.

Output from the throttle goes into the combustion chamber where combustion occurs providing the output requested.

Space considerations may require a method (likely injection but other methods can work) for inputting a controlled amount of water either before or after the throttle valve that may be used for helping to reduce combustion temperatures at higher output settings. At higher output settings with correspondingly higher combustion temperatures, the cooling from those combustion temperatures to prevent wastage of power and production of NOx pollutants is provided by this injection. Alternatively, more volume may be devoted to combustion chambers and EGR alone used to keep the combustion temperatures low enough to avoid NOx production.

### Ramifications

Fuels are commonly combined with the oxygen from the air, ignited and combusted. The resultant burning providing light, heat and power in the form of an expanding burning fuel-air mixture. Hydrocarbon fuel-air mixtures have an optimal stoichiometric mixture where each carbon atom can combine with two oxygen atoms in an exothermic reaction to produce the maximum amount of energy. Unfortunately despite many improvements, past and current designs do not accomplish this without the unfortunate side effects of incomplete combustion, pollution and/or inefficiency. EMOCI maximizes the output of a given amount of fuel while at the same time minimizing pollutants other than carbon dioxide. Modifying present furnaces and engines as well as future designs to EMOCI design will improve fuel efficiencies, reduce the draw down of limited resources, vastly reduce pollution such as smog and acid rain, and increase life expectancies.

### Scope

Designs utilizing combustion chambers can be modified to use an EMOCI. All the required parts are already in use in the industry, though some will be improved by modification. Many variations of these modifications are possible. EMOCI techniques of using EGR and water injection can be used with short intakes post fuel mixing with the air or with direct injection of fuel into the combustion chamber but in that case would retain the problem in getting adequate mixing of fuel and air.

### Conclusion

By optimizing the fuel-air mixture throughout the output curve this relatively simple modification to combustion design makes better use of a limited resource and results in less pollution.

1. A method and/or device of realizing near optimal fuel to air ratios throughout the entire output range of combustion by recycling of controlled quantities of exhaust gases displacing similar quantities of incoming air.

2. A method and/or device according to claim 1 that primarily controls the quantity of air intake via such displacement.

3. A method and/or device according to claim 1 optionally using injection of matter (such as water) that can modify the temperature of the combustion.

4. A method and/or device for throttling combustion by displacement of incoming air with effectively inert recycled exhaust, primarily adjusting combustion output by recycling of controlled quantities of exhaust gases displacing similar quantities of incoming fuel-air mixture.

5. A method and/or device according to claim 4 capable of combining fuel with the air mixed at a predetermined (optimally stoichiometric) ratio.

6. A method and/or device according to claim 4 that can supply time for vaporization of fuel via length of intake tube.

7. A method and/or device according to claim 4 that controls intake of fuel, air and recycled exhaust into the combustion chamber in a ratio that can be stoichiometric throughout the entire output demand curve while still delivering a consistent quantity of intake gases towards a combustion locale.

8. A method and/or device according to claim 4 optionally using injection of matter (such as water) that can modify the temperature of the combustion.
